(19) United States
(12) Patent Application Publication
(10) Pub. No.: US 2015/0244307 A1
(43) Pub. Date: Aug. 27, 2015

(54) MODULAR STRUCTURAL SYSTEM FOR SOLAR PANEL INSTALLATION

(71) Applicant: D. Kevin Cameron, Sunnyvale, CA (US)

(72) Inventor: D. Kevin Cameron, Sunnyvale, CA (US)

(21) Appl. No.: 14/707,191

(22) Filed: May 8, 2015

Related U.S. Application Data
(63) Continuation of application No. PCT/US2013/069351, filed on Nov. 8, 2013.
(60) Provisional application No. 61/723,786, filed on Nov. 8, 2012.

(51) Int. Cl. H02S 20/23; H04B 1/38; E04B 7/18

(52) U.S. Cl. CPC H02S 20/23; E04B 7/18; H04B 1/38

(57) ABSTRACT

A support structure (SS) and method for mounting SS and solar equipment on pitched roofs. Preassembled SS is installable/ removable, as a single module for reduced cost, installation time, and hazards. Optional housing for battery, electronics, and wireless equipment, is disposed in portion of preassembled SS that resides in protected interior of building. An elevated attach point on the SS optionally accepts cellular and high-frequency transceivers (for mesh network). SS penetrates roof, not on leak-prone roof face, but at roof apex using a main support coupleable to internal building structure. An interface member on the main support has a shape that is conformal to the roof apex to provide a weatherproof seal, load support, and a fulcrum to absorb equipment torque. Padded-standoffs support equipment weight on roof. Optionally, SS frame tubing acts as wire-conduit or SS frame is configured as power conductor for low-voltage, parallely-coupled, independently-troubleshootable, solar panels.

### CROSS-REFERENCE TO RELATED APPLICATIONS

This application is a continuation of, and claims priority to, PCT International Application No. PCT/US2013/069351, by D. Kevin Cameron, entitled “MODULAR STRUCTURAL SYSTEM FOR SOLAR PANEL INSTALLATION,” having an international filing date of Nov. 8, 2013; and also claims priority to provisional application, U.S. Ser. No. 61/723,786, filed Nov. 8, 2012, entitled “FRAMING FOR SOLAR PANELS WITH REDUCED FRAME-TO-ROOF INTERFERENCE,” and claims priority to provisional application, U.S. Ser. No. 61/775,700, filed Mar. 11, 2013, entitled “FRAMING COMPONENTS FOR REDUCING SOLAR PV INSTALLATION COSTS,” both of which applications are also incorporated by reference herein, in their entirety.

### FIELD OF TECHNOLOGY

This disclosure relates generally to the technical field of installation of equipment on a roof, and in one example embodiment, this disclosure relates to a method, apparatus and system of installing solar panels and a structural support for the solar panels on a roof.

### BACKGROUND

In the early development of the solar photovoltaic (PV) industry, the dominant cost component of a system was the PV cells. Over time, the cost of PV cells dropped substantially. As a result, the “balance of system” costs are now a large portion of the cost of buying and installing a solar system. The “balance of system” costs include the use of skilled labor and the cost of other hardware.

Since housing is a durable good with a long lifetime, a PV solar system can be utilized on a given roof installation for a substantial amount of time, with the lifetime of the roofing not coincident with the lifetime of any solar installation. Tile roofs are particularly difficult to retrofit with solar PV because drilling holes in tile is difficult and can result in breakage of the tile. However, residential roofs are a good target market, as opposed to commercial rooftops, because residential roofs typically have a substantial amount of unused space on both the outside and inside with easy access to wiring.

Existing approaches also tend to damage the integrity of the roofs on which they are installed by requiring supports and wiring conduit to pass through the main section of the roof In addition, existing installation techniques are not designed for serviceability of the PV system or the roof Many solar installations utilize standoffs that attach to a housing structure by using fasteners that pierce the roof shingles and rafters. Flashing and caulk is used to reduce leakage around these breaches in the roof However, any hole made in the face of a roof, between the apex of the roof down to the lip of the roof by the fascia, which area is over living quarters, reduces the lifespan of the roof and is apt to cause leakage and integrity problems much sooner than if the roof was not breached. For the PV system to be replaced for an upgrade or repair, skilled labor is required to disconnect the high-voltage electrical wiring of the PV system. Moreover, the disassembly of the PV system is time-consuming and painstaking because of the number of standoffs fastened to the building structure and because of the many rails, brackets, and fasteners used to retain the PV solar panels.

In addition to the need for clean energy, modern society has an insatiable demand for communication bandwidth. 4G/Long Term Evolution (LTE) cellular bandwidth is already fully subscribed and in order to create more a move to smaller cells is required and/or higher frequencies. Unfortunately higher frequencies (25 GHz and up) cannot penetrate buildings, and people object to cell towers in their backyards.

### SUMMARY

An apparatus, system, and method of installation for a support structure of roof mounted equipment, specifically solar panels, on a pitched roof Modules are prefabricated, then lowered onto a roof using a single hole or access point in the roof to connect the module to the building structure, and to couple wiring to electrical loads, either in the house or on the module or to a grid. A hole is utilized at the apex of the roof where the structural impact is minimal and potential damage from any leaks is minimized. The part of the module that drops into the roof space contains the power electronics. The entry hole in the apex is sealed and protected such that water will not penetrate through it. A clamping structure is attached to the part of the frame in the roof space, which either clamps it to the roofing material or to the roof supports. A module may have any number of any size panels, focusing on a cost effective size for transportation and for fitting popular sizes of roof (from the apex to the gutter). On a wide roof, multiple independent units may be installed.

Standoffs are attached to the framing to keep it the desired distance from the roof surface, but do not attach to the roof. Standoffs are made from flexible material to absorb variations in roof materials. The power electronics that converts the unregulated panel power to usable regulated power is attached between the main support pieces in the roof space, since this is beneath the roof, typically in an interior building space such as an attic, which is protected from the elements, and results in a cheaper interior-grade housing (vs. a NEMA 4 rated exterior box). The power electronics housing includes a large (extruded) aluminum heat sink that is multi-functionally coupled between the framing uprights for rigidity. After being lowered into place a “clamp beam” is attached to the framing on either or both sides of the framing to attach it to the roof

Framing components can use steel or aluminum having cross-sections of an L-bar, T-bar, and square or round tube. Standoffs and panel clamps may be made of metal or non-conductive materials, and may be threaded onto the framing and glued/welded rather than using bolts since with preassembly the construction time will not affect the installation time.

Typical roofing structure is composite shingle over plywood and wood rafters, to which the ends of the clamp beam can be attached (if required). If the roof is tile on top of a wood frame (or similar), the clamp beam is attached to the rafters (if flat) or around them (if shaped to do so, e.g. by wrapping around the open sides of the rafter). The framing and clamp have a bolt hole pattern such that it can accommodate different thicknesses of roof, and thus allow secure attachment with only one bolt per clamp beam (attachment of ends being optional). Since roof rafter spacing is normally a fixed size, the spacing between the framing members can be set such that the clamp beams are close to the rafters on both sides for more secure attachment. To save material or fit tighter spaces the clamp beam may be constructed such that it only extends in one direction. The clamp may also include flanges to stop it from twisting vs. the frame. Where the roof rafter spacing is significantly larger than the framing width and a single clamp is insufficient, alternative clamp configurations with a longer reach are used. In building structures using a (structural) beam along the apex of the roof, the vertical part of the framing can pass beside it and the weatherproofing plate(s) would be offset as required.

As an alternative or in addition to clamping, a “battery basket” may be hung from the internal end of the framing that will act as ballast as well as providing safe housing for batteries for storing the solar power.

While a single pitch of PV, e.g., facing south on a building, is expected to be the common configuration, another embodiment accommodates multiple different pitches, e.g., where the pitches face east and west on the building and receive similar amounts of sunlight over a day.

Since the structure and PV panels are preassembled, no external wiring/attachment is performed during installation, and thus, the exterior parts of the equipment can be sealed against the elements prior to installation. This allows the use of materials like steel, rather than aluminum, which is cheaper and more weldable. Welding results in better electrical contact if the framing is used to transfer power.

If metal tubing is used for the uprights, (e.g. square pipe) it may double as conduit for wiring. In addition, it may serve as a place to plug in antenna brackets (see below), in which case simple end-caps may be used to seal the tubes that can be “popped” out so that additional framing can be added after initial installation. Note that the lower end of the tube would be exposed below the electronics so that water ingress through the tubes would not leak onto electronics.

Solar panels can be wired in various configurations, where wiring codes allow: the frame may be used as an electrode to reduce costs further. If the two framing members are electrically isolated then they may be used to carry all the power off the roof (one as the positive connection the other as the negative connection). The power electronics can use its mechanical attachment to the framing as its electrical contact, eliminating the need for special connectors. Otherwise, the PV cables will pass through the rain deflection plate via watertight grommet (or similar), or inside the framing

The minimum cost and maximum efficiency implementation uses the framing for power transfer from parallely coupled PV panels managed by maximum power-point tracking (MPPT) electronics on each panel so that the voltage going into the roof space is low (sub 50V is preferable for US wiring codes), and there is redundancy among the panels. Electrically insulative paint on framing parts is sufficient dielectric protection below 50V, and cross pieces, such as the rain deflector plate, can be constructed from non-conductive material (fiberglass, ABS, etc.). In addition, MPPT tracking electronics can be designed to shut off power automatically when it senses an arc fault. Low voltage systems can also use parts designed for automotive systems that are cheaper due to their volume production.

Roof pitches are variable, but the prefabricated unit can be used over a wide range of pitches because the load-bearing member extending into the roof space does not have to be vertical. The rain deflector plate, known also as the interface member, can be hinged at its apex to accommodate the different roof pitches, using a fastener hinge pin that can be tightened once the pieces are in place to hold the desired angle, with optional welding of the hinged interface member for security/connectivity. For a two-sided roof with mirror pitches, the same angle will be set for both halves of the interface member. For single pitch roofs that end at an exterior vertical wall, one half of the interface member would be rigidly attached to the panel framing, while the other half would be attached to the building structure flexibly, using foam, Silicone sealants, and/or boots for weatherproofing. Another embodiment uses a per-pitch hinging. Welding may also be used to achieve more reliable connectivity and structural integrity, either prior to shipment to a known roof pitch, or on-site prior to installation for an unknown roof pitch.

If an installation requires extra stability (under strong winds etc.), the frame may be tied down using steel wire(s) from attachment points on the lower end of the frame to assemblies at the lower edge of the roof, e.g., at or around the gutter, where the main roof area's integrity will not be compromised if holes are drilled (i.e. any leaks caused will be beyond the walls). If the framing runs all the way from the apex to the lower edge of the roof by the gutter, the lower standoffs may be constructed such that they attach to the roof by screws or bolts. Attachment points on the framing used for hoisting the PV assembly onto the roof double as tie-down points. If the framing extends beyond the gutter, it may be tied down to the wall supporting the roof.

The same equipment can be used on mono-pitch or mid-pitch roofs if the rain deflection plate is laid under the upper side shingle or tile.

Residential installation can be accomplished by one to two workers. One person would be on the roof to cut the hole and guide the unit, the second would operate a “cherry picker” to lift the units from a delivery truck to the roof. Hoops, or lift-brackets, can be welded to the framing to aid hoisting the unit. Once in place a technician can finish the installation from within the roof space. If the cherry picker in question can be operated by remote control, then a single person could perform the entire installation if also qualified for internal wiring. Removal of the frame and PV panel for servicing utilizes the reverse process, i.e. no in-place servicing of the PV panel and electronics is required. Instead, the unit is removed and replaced or upgraded.

The PV panels can be sized such that on roofs where multiple units are installed, adjacent units have some small clearance, assuming a unit falls between alternate sets of rafters. The appearance from the ground is then similar to existing systems where panels are abutted (making maximum use of the roof space), but has the advantage that any single unit can be removed for service/replacement.

The standoff design will depend on the roof construction, but for clay/ceramic tiles plates with a foam or rubber cushion that can adjust to the tiles are used so no high pressure points exist that otherwise might cause a fracture, and the weight is spread over a number of tiles. The foam/rubber is deeply ribbed so that water can drain through and not collect on the top side.

In simple installations, one would expect the output of the power electronics to be grid-tied AC power. Some additional redundancy can be achieved by wiring the DC side of the inverters in parallel between units so that on the failure of an inverter stage in any unit its power will be transferred to other units, thus avoiding complete loss of the unit. The DC bus created by doing this may be used directly for off-grid power.

Since this framing system is intended to sit at the highest point on a roof, it makes an excellent platform for antennas for line-of-sight networking. In addition, because this design is expected to be deployed on many roofs, it is particularly well suited for implementing small cells and mesh networks in the 60-80 GHz range. Add the availability of solar PV and battery backup power for the transceivers, and the result is an extremely reliable network. Electronics for relaying network traffic may be combined with the power electronics for the solar, bridging to networks that will work inside the residence or with standard cell phone networks. In particular, this may be used with high bandwidth fiber-optic wiring like that used with a DC bus system to bridge gaps in fiber-optic distribution.

### BRIEF DESCRIPTION OF THE VIEW OF DRAWINGS

Example embodiments are illustrated by way of example and not limitation in the figures of the accompanying drawings, in which like references indicate similar elements and in which:

FIGS. 1A-1C are a front view, top view, and side view of a building structure having a preassembled support structure and solar panel unit, on one side of a two-sided roof, that pierces the roof only at the apex, according to one or more embodiments.

FIG. 1D is a front view of an alternative single-slope roof architecture having a preassembled support structure and solar panel unit that pierces the roof only at the apex, according to one or more embodiments.

FIG. 1E is a front view of a building structure having a preassembled support structure and solar panel unit, on both sides of a two-sided roof, which pierces the roof only at the apex, according to one or more embodiments.

FIG. 2A is an oblique view of a preassembled framing system, with integrated electronics module and battery module, which is installable as a single unit on a roof, according to one or more embodiments.

FIG. 2B is a cross-section of a square-tube rail for supporting a solar panel in the support structure and for providing a conduit enclosure for power and ground wires, according to one or more embodiments.

FIG. 2C is an oblique view of an angle-iron rail for supporting a solar panel in the support structure, including a conduit enclosure for power and ground wires, according to one or more embodiments.

FIG. 2D is a view of a standoff for a composite shingle roof, according to one or more embodiments.

FIG. 2E is an oblique view of a standoff with a grooved silicone pad for a tile roof, according to one or more embodiments.

FIG. 2F is an oblique view of a multiple transceiver attachment to the support structure, according to one or more embodiments.

FIG. 2G is an oblique view of a hinged interface member, according to one or more embodiments.

FIG. 3A is a top view of a PV panel assembly cascaded down an extended-height roof, according to one or more embodiments.

FIG. 3B is a side view of a telescoping support rail system, according to one or more embodiments.

FIG. 3C is a side view of a cable-tensioned telescoping support rail system, according to one or more embodiments.

FIG. 4 is a flowchart of a method to install and remove a modular PV support structure, according to one or more embodiments.

Other features of the present embodiments will be apparent from the accompanying drawings and from the detailed description that follows.

### DETAILED DESCRIPTION

An apparatus and system for a support structure (SS) and a method for mounting (solar) equipment and the support structure onto pitched roofs. In the following description, for the purposes of explanation, numerous specific details are set forth in order to provide a thorough understanding of the various embodiments. It will be evident, however to one skilled in the art that various embodiments may be practiced without these specific details.

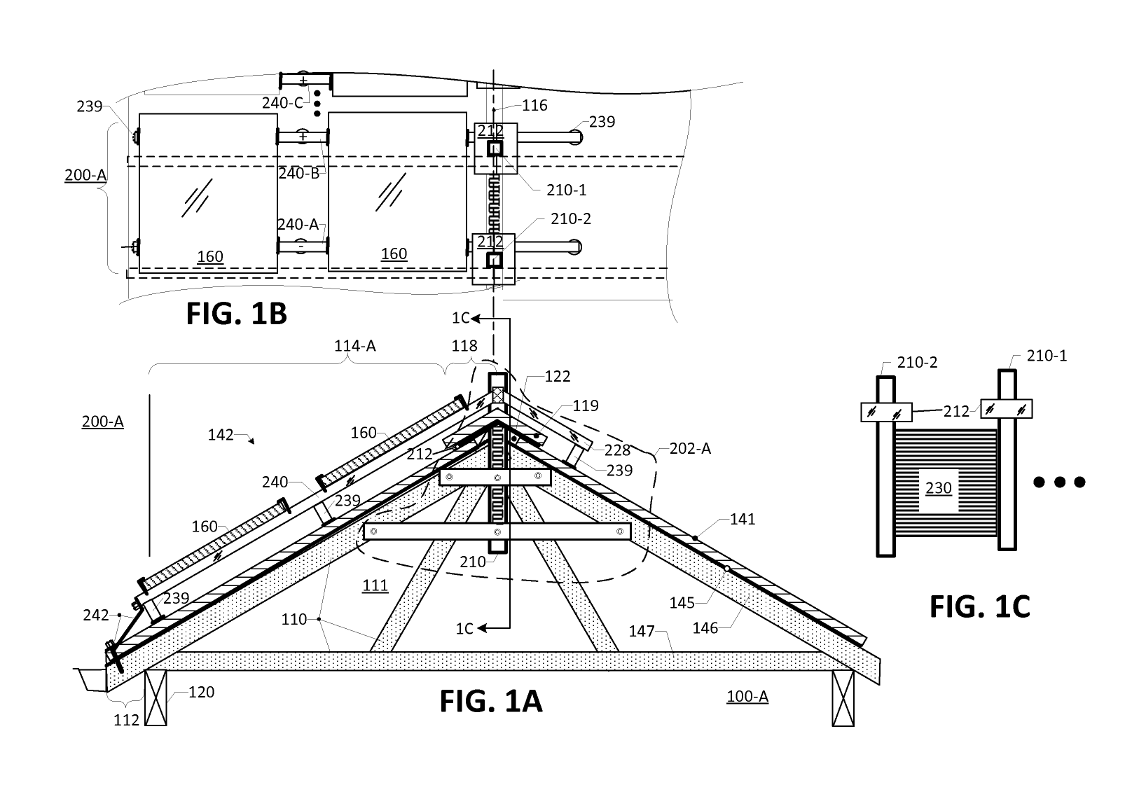

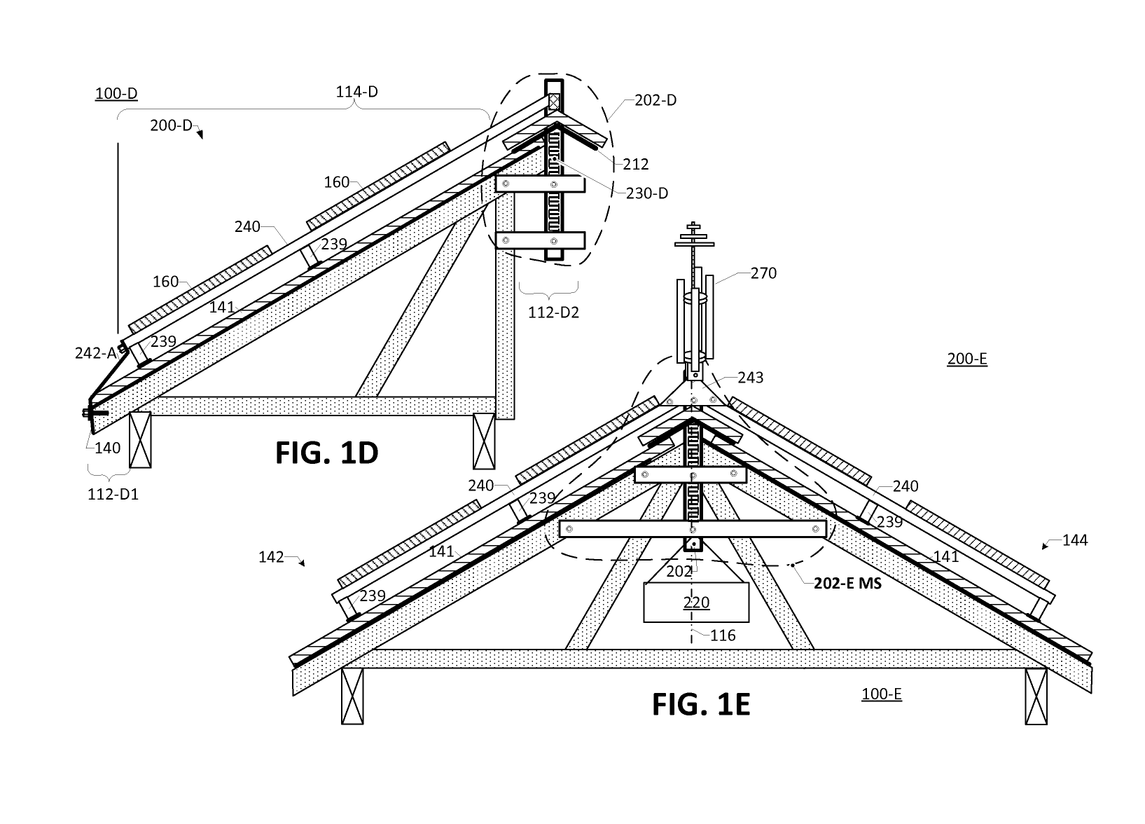

Referring now to FIGS. 1A-1C, a front view, top view, and side view of a building structure 100-A having a preassembled support structure and solar panel unit 200-A, also referred to as a pre-assembled module, on a first side 142 of a two-sided roof, that pierces the roof 141 only at the apex 116 is shown, according to one or more embodiments.

The support structure (SS) 200-A includes at least one support rail 240 for supporting the equipment, i.e., solar panels 160, coupled to one or more standoffs 239 for maintaining the equipment 160 at a distance away from a face 114-A of the roof 141. SS 200-A is preassembled off the roof for installation on the roof 141 as a single unit. SS 200-A requires no fasteners to penetrate the face 114-A of the roof in order to retain the SS 200-A to the building structure 100-A. SS 200-A does penetrate the roof 141 of the building structure, but not on the face 114-A of the roof. Rather, SS 200-A penetrates the roof only at a region 118 covered by the ridge shingle 119 at apex 116 of the roof 141. The one or more standoffs 239 have no retention feature to couple them to the roof of the building structure, e.g., no fasteners, holes for fasteners, etc. that would penetrate roof 141. The one or more standoffs 239 transmit only a compressive load toward, and not a tensile load away from, the surface of the roof without penetrating the roof. The SS 200-A with solar panels 160 is preassembled off the roof for installation on the roof as a modular unit.

The main support (MS) 202-A includes a load-bearing member 210, and an interface member 212 has a face that mates with the apex of the roof, i.e., the inverted “V” shape that matches the inverted “V” shape of the apex of the roof. Additionally, interface member 212 is larger than the gap, or roof opening, 122 formed through the plywood sheet 145 through which the LBM passes. Beneficially, the interface member 212 provides at least one of a pivot point for any torque loads from the equipment, a physical support of weight load of the equipment 160 and balance of support structure 200-A, and a weather shield for the hole in the roof. Only the portion of load-bearing member 210 located below interface member 212 extends beyond an imaginary plane formed by the interface member 212 in order to penetrate through the apex 116 of roof 141 into interior space 111 where SS 200-A will be attached to interior structure 110, i.e., SS 200-A will be attached to rafters 146 in attic. The imaginary plane of the interface member 212, when installed on the building structure 100, is the roof surface 141 under each respective side of the interface member 212. Optionally, a brace member may be extended to joist 147 for extra support.

The MS 202-A additionally includes a counterbalance member 228, coupled to the LBM 210, for absorbing torque-loads generated by the equipment, e.g., wind load on solar panels 160. While counterbalance member 228 is capable of absorbing all torque loads of module 202-A, the present embodiment, also includes a tie-down member 242 coupled to at least one support rail 240 and has a length that allows the tie-down member to be attached to the building structure 100-A at a location, e.g., overhang 112, that is outside of face 114-A of roof 141, such that face 114-A of roof 141 is not penetrated, thereby preserving the waterproof integrity of the face 114-A of roof 141. In one embodiment, only a single tie-down 242 is required to retain a lower-end of the entire SS 200-A.

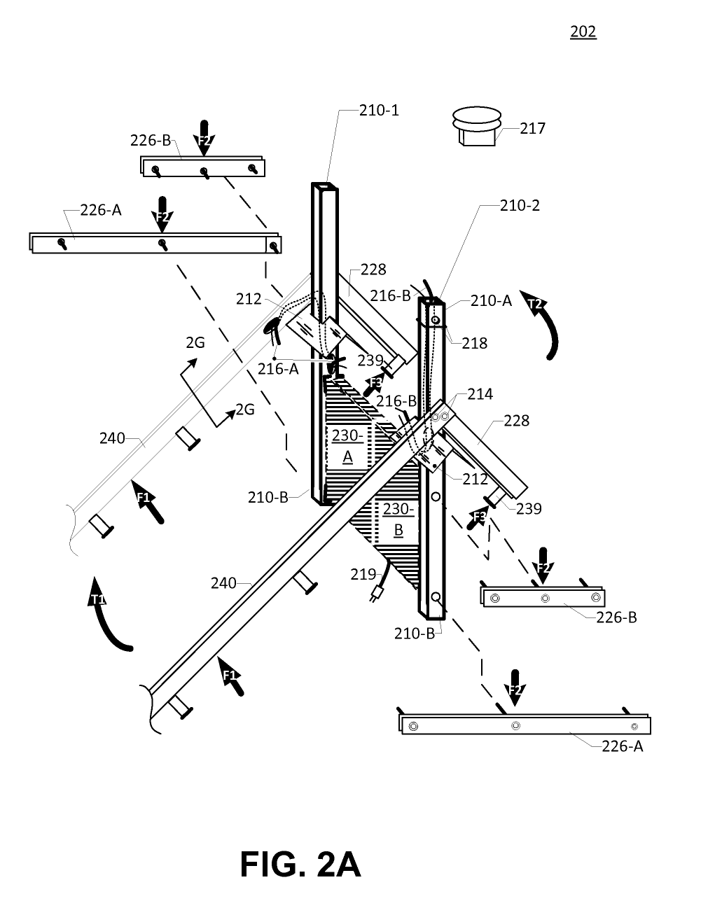

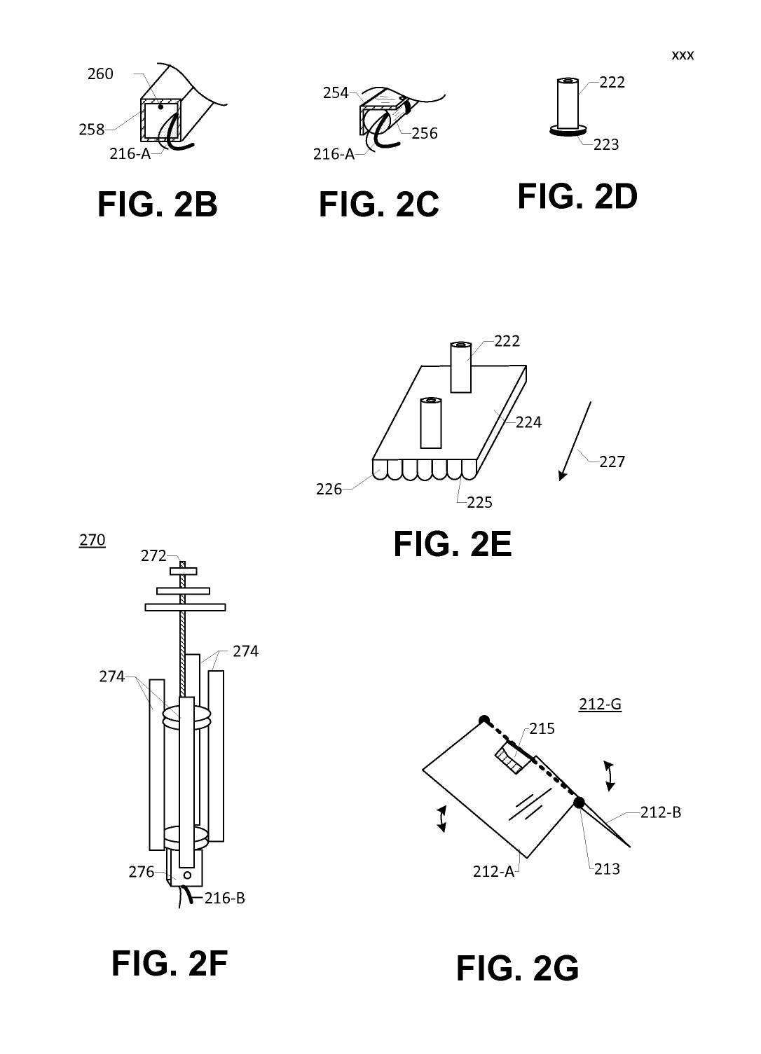

While power transmission from solar panels 160 is provided by traditional wiring 216-A, as shown in FIG. 2A, the present embodiment is well-suited to utilizing support rails 240 and main support 202 to conduct power to inverters, especially if module 200-A is operated at low-voltage, e.g., sub-50V in US, thereby making it a low-risk hazard. In this latter embodiment, the plurality of rails, i.e. first rail 240-A and third rail 240-C (for an additional parallel module only partially shown) are selectively coupled to each other electrically, and to the renewable energy source (solar panels), according to polarity, i.e. positive (+), and are selectively coupled to at least one of the load-bearing members 210-1 electrically, according to polarity, (+), in order to conduct current generated by a solar panel 160 to the electronics housing 230. Similarly, a second rail 240-B is electrically coupled to a second polarity (−) of the renewable energy source, and physically coupled to a second LBM 210-2, which has the same polarity. Rails of one polarity, i.e., 240-A are electrically insulated from rails of a different polarity, i.e., 240-B and -C, both of which are coupled to electrical devices in interior 110 of building 100-A to provide isolation required by safety rules, and a less harsh interior setting allowing for less-expensive interior-rated electronics. The ultimate destination of the power is one or more electrical loads of a battery, a device in the building structure, and a grid, e.g., via optional power electronics housing 230-A, -B of FIG. 2A, where the power can be conditioned and the voltage boosted for DC or AC applications. Connections from solar panels 160 and power electronics in housing 230-A to rail 240 and LBM 210 can be made by welding pieces together, or by connecting support structure components with self-tapping fasteners, that cut a clean metal connection, and using rubber-sealed washers to provide a moisture proof sealing, which reduces corrosion and resistance buildup.

Referring now to FIGS. 1D, a front view of a building 100-D with an alternative single-slope roof architecture is shown having a preassembled support structure 200-D with solar panels 160 that pierces the roof only at the apex, according to one or more embodiments. Since the architecture 200-D is a single-slope without a mirror copy of the roof on the opposite side of the apex, there is an overhang 112-D1 on the lower part of roof 141 and an overhang 112-D2 on the upper part of roof 141, to which the support structure 200-D can be either tied down or attached without penetrating roof face 114-D, thus preserving roof integrity. Ridge shingles are not used in a standard single-pitch roof of the present embodiment, but then can be used to cover interface member 212. Consequently, a single preassembled module can still be utilized for installation as a single unit to save time and money in the present embodiment. However, the housing for battery and power electronics need not be an exterior grade NEMA 4 rated exterior box.

Referring now to FIGS. 1E, a front view of a building structure 100-E is shown having a preassembled support structure and solar panel unit 200-E, located on both sides of a two-sided roof 142, 144, which pierces the roof 141 only at the apex 116, according to one or more embodiments. The present embodiment provides a more balanced solution than FIG. 1A having PV panels only on one side of the roof, though it is most likely applied to an east-west oriented apex, providing a similar sun exposure on both sides 142, 144 of the roof. Optional gusset assembly 243 provides improved torque-absorbing capability and balance in the support structure 200-E. Optional battery basket 220 coupled to bottom of load-bearing member 202. All three factors of the gusset 243, battery ballast 220, and balanced modules 200-E enable the present configuration to eliminate a tie down of the lowest portion of the module 200-E The main support 202-E absorbs all of a torque load generated by the equipment on the SS in one embodiment. Thus, no tie-down is needed to retain a lower end of the SS 200-E.

Referring now to FIG. 2A, an oblique view of a preassembled main supports 202 is shown with integrated electronics module and battery module, which is installable as a single unit on a roof, according to one or more embodiments. Also shown are rails 240 and standoffs 239, coupled to main support 202, for supporting weight of solar panels 160 against roof 141 as shown in FIG. 1A. Main support (MS) 202 includes two load-bearing members 210-1, -2, each having a first end, 210-A a second end 210-B, and an interface member 212 disposed between first end 210-A and second end 210-B, wherein interface member 212 has a face that mates with the apex of the roof, e.g., an inverted “V” and is larger than the gap 122 through which the second end 210-B of LBM 210, as shown in FIGS. 1A-1C. MS 202 optionally includes a housing 230-A and 230-B, slated for storing at least one of a power electronics for solar panels 160, signal processing electronics for optional transceiver, and a battery, respectively, and coupled to second end 210-B of the LBM 210 and disposed below the imaginary plane created by each leg of the inverted “V” of the interface plate 212 such that housing 230-A, -B will be located below the roof 141 when installed in the building structure, as shown in FIGS. 1A, 1D, and 1E. Housing 230-A includes a battery that provides backup power for an electrical system of the building structure, an optional transceiver, or a power grid. Optional adapter mount 218 disposed on first end 210-A of LBM 210 is for receiving at least one transceiver, such as that shown in subsequent FIG. 2F, which will be disposed above apex 116 of the roof 141 in order to provide a line of sight for transceiving, e.g., in a mesh network.

Rail 240 and load bearing member 210 can be utilized as a conduit to route power and ground wires 216-A across the roof plane to an interior space 110 of building 100, as shown in FIG. 1A. Similarly, load bearing member 210 can be used as a conduit to route power, ground, and data lines 216-B from first end 210-A of LBM 210 to an interior space 110 of building 100, for access to power electronics and digital signal processing equipment disposed in housing 230-B. Power plug 219 can be used for supplement power, e.g., to optional transceiver device 270 of FIG. 2F, if coupled to main support 202.

As an example of the torque absorbing capabilities of main support 202, as applied to a building structure of FIG. 1A, if a force F1 is exerted on rail 240, such as a wind load during a storm, it creates a torque T1 that tries to lift the lower portion of support structure 200-A off a roof 141 . A balancing force F3 is applied to standoffs 239 of counterbalance members 228 at the roof 141 to create a counter-torque T2.

Referring now to FIG. 2B, a cross-section of a square-tube rail 258 is shown for supporting a solar panel in the support structure and for providing a conduit enclosure 260 for power and ground wires, according to one or more embodiments. Square-tube rail 258 has an internal cavity through which wires may be routed. This reduces installation materials for separate conduit, and labor spent to bend the conduit and affix it to the support structure. Similarly, in FIG. 2C, an oblique view of an angle-iron rail 254 is shown for supporting a solar panel in the support structure, including a conduit enclosure 256 for power and ground wires, according to one or more embodiments.

Referring now to FIG. 2D, a view of a standoff 222 for a composite shingle roof is shown, according to one or more embodiments. Standoff includes a flexible face piece 223 that interfaces with the composite shingle roof, e.g., roof 141 of FIG. 1A. Face piece can be any weather resistant material that offers elasticity and shock absorption while avoiding adhesion over time to composite shingles. Similarly, FIG. 2E shows an oblique view of a standoff 222 with a wide base 224 and silicone pad 226 for low unit loading on a tile roof, according to one or more embodiments. A softer silicone material absorbs more loads without transmitting them to the clay roof tile, which may otherwise crack. Silicone pad 226 is grooved 225 in a downward direction 227 of roof, to allow flow of water there through and to provide breathing to avoid adhesion to the tile.

Referring now to FIG. 2F, an oblique view of a multiple transceiver attachment to the support structure is shown, according to one or more embodiments. Transceiver assembly 270 includes any one or more communication protocols, such as a cellular transceiver 274 coupled to the adapter mount 276 for providing a microcell station for local cellular communications. Another possible transceiver coupleable to the adapter mount of the SS is a high-frequency transceiver 272 for providing a short reach relay communication to another high-frequency transceiver in a mesh network in order to transmit data between the microcell stations and an edge router that is coupled to a switching office or other backhaul service. By having transceiver assembly 270 located on ubiquitous solar installations, a natural mesh grid is available across a typical urban or suburban neighborhood, which is where bandwidth is in demand for wireless communications.

Referring now to FIG. 2G, an oblique view of a hinged interface member 212-G is shown, according to one or more embodiments. Hinged interface member 212-G flexibly adjusts the two flanges 212-A and 212-B to match a specific roof pitch within a wide range of possible roof pitches. Hinge pin 213 is threaded on one end with a capture bolt to provide a clamping of desired position. Alternatively, hinged interface member 212-G can be welded during preassembly for a known roof pitch or welded in the field for an unknown roof pitch. Cutout 215 is oversized to accommodate steep roof pitches that require a longer cutout, as compared to a shallow pitch roof that requires a smaller cutout. A rubber grommet can also be provided around LBM 210 to fill any gaps with cutout 215 in interface member 212. Pin 213 can be threaded through LBM 210 to offer further retention of LBM 210 on building structure 100.

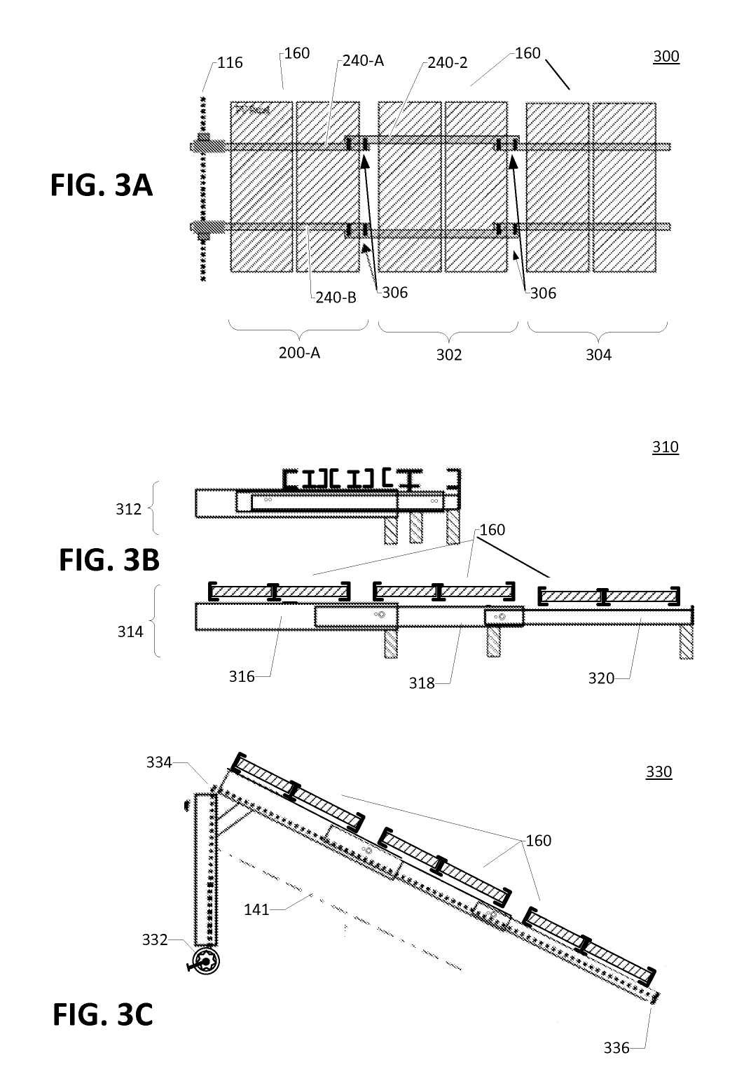

Referring now to FIG. 3A, a top view of a cascaded PV panel module 300 down an extended-height roof is shown, according to one or more embodiments. A typical module 200-A of PV panels 160 is similar to that shown in FIG. 1A. However, in the present embodiment, additional sets of panels 302 and 304 are coupled serially down a roof of a building structure, with rails 240-A and 240-B coupled to respective rails in subsequent modules via fastening means 306. A serial arrangement as shown would require a tie down on the end of panel set 304 furthest from apex 116. This embodiment would require some on-roof assembly due to the length of the module

Referring now to FIG. 3B, a side view of a telescoping support rail system 310 is shown, according to one or more embodiments. View 312 illustrates a closed, or retracted, position of the telescoping rails 316, 318, 320 while view 314 illustrates an expanded or deployed position of the telescoping rails. 316, 318, 320, with installed solar panels 160, each of which is slightly larger than the one nesting within it. This embodiment allows for more compact storage and shipment of solar systems having more solar panels in a module than provided in FIG. 3A. Telescoping rails can have a series of holes that allows for some flexibility in length for different roof sizes. Fasteners lock the telescoping rails into their final position for deployment.

Referring now to FIG. 3C, a side view of a cable-tensioned telescoping support rail system 330 is shown, according to one or more embodiments. Cable 334 is fixed at end 336, retractable by reel 332 for storage and shipment of module 330. Once telescoping rails 316, 318, and 320 are extended and fastened to their proper length, a tension can be placed on the assembly via cable 334 to ensure rigidity and integrity.

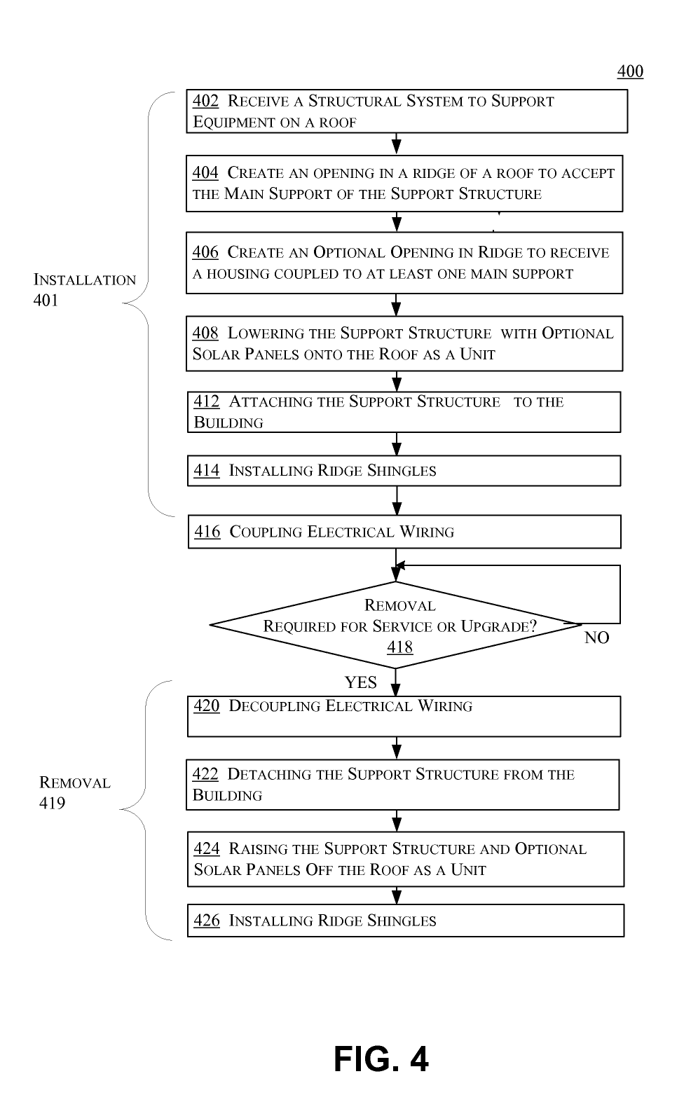

Referring now to FIG. 4, a flowchart 400 of a method to install and remove a modular PV support structure is shown, according to one or more embodiments. Flowchart 400 is described herein as implemented on exemplary support structure 200 on building structure 100-A of FIGS. 1A-1C, unless noted otherwise, including the alternative embodiments described herein.

Operations 402 through 416 provide for installation procedure 401. In operation 402, a support structure 200-A is received for supporting equipment, notably PV solar panels 160, on a roof 141 of building structure 100-A. Structural system 200-A is received as a modular unit, e.g., delivered by flatbed truck at the work site, with solar panels 160 installed, and optional battery and power electronics housing 230-A and -B of FIG. 2A, already installed and wired. Sensitive optional equipment, such as transceiver assembly 270, can be installed in situ, on the roof, after support structure 200 is secured in order to avoid damage. Because support structure 200 is preassembled, including pre-wiring, installation on building 100-A is greatly simplified, thereby saving time and money. Operation 402 can be scheduled after operation 406 for labor efficiency.

Operation 404 requires the creation of an opening in a ridge of a roof to accept the main support of the structural system. The first sub step is to remove the ridge shingles/ the 119 to get access to the wood panel sheets 145 thereunder, e.g., plywood or OSB On a new house, the plywood base of the roof can be cut short, thereby leaving a gap, or opening, 122 at the apex 116 of the roof 141 to receive the portion, e.g., 210-B end of load-bearing member, of the support structure 200 that penetrates the plane of the roof 141 to be disposed in the interior space 111, e.g., an attic. Many houses already have this gap 122 at the apex 116, for installation of a ridge vent. In this case, the sheet metal or plastic ridge vent can be cut out to create the necessary gap. In operation 406, an optional opening in apex, or ridge, 116, is created to accommodate housings 230-A, -B of FIG. 2A for the battery and power electronics.

Turning to operation 408, the preassembled modular support structure 200 is lowered onto the roof, without upper and lower cross braces 226-B, -A attached. A semi-skilled worker can make the installation single-handedly if she is qualified for low-voltage wiring, and if the boom lift used to raise and lower the support structure 200 is remotely operable. Support structure 200 is lifted by lift hooks/hoop flanges installed on the support structure, or by a webbed strap under the structure, and the second end 210-B, with associated housings 230-A, -B, is then threaded through the opening 122 in apex 116 into the interior space 111 of building structure 100-A. The support structure is seated when the interface member 212 and standoffs 239 naturally come to rest against the roof 141. At this point, there is no need to fasten the support structure to the roof to prevent it from sliding down the roof, because the load-bearing member 210 is sufficiently strong to retain the base weight of the support structure 200, save a condition of unusually strong winds.

In operation 412, the installer can secure support structure 200 to building structure 110 by installing cross-brace 226-A, -B in the interior 111 space, either by threaded lug bolts or by clamping mechanism. Because the load-bearing member 210 is installed adjacent to the rafter 146, the interface member 212 loads down on the plywood 145 as well as on the rafter 146, thereby providing structural integrity. An alternative cross brace could capture a bottom-side of a rafter 146 thereby placing the height of the rafter 146 in compression while pulling down on load-bearing member 210 in tension, thereby ensuring a pre-loaded main support 202. Optional tie-downs 242 can also be attached in this step, especially for support structures that are lengthy, i.e., more than two panels. For two-panel support structures 200, the cross-bracing 226-A, -B and optional counterbalance member 228 are sufficient.

In operation 414, ridge shingles are installed. The ridge shingle 119 is the easiest and least risky shingle to replace on the roof because they are easily replaced, and they do not disturb any adjacent shingles. In fact, a carefully removed ridge shingle can be reused after the support structure is installed, thus guaranteeing shingle color matching and reducing cost. In comparison, replacing shingles midway down a roof if needed in a traditional solar system installation does disturb adjacent shingles, especially those layered over the shingle of interest, with a frequent side effect of causing leaks.

In operation 416, electrical wiring is coupled from the building's power system(s), as well as wires 216-B for transceiver operation (if it is being added independently on-site to avoid damage during operation 402). Optional AC building power is provided via outlet 219. Power electronics in housing 230-B can provide maximum power-point tracking (MPPT) on a per-module basis, e.g., for the two solar panels 160 shown. Additional modules installed side-by-side on roof 141 provides parallel sources of power, each with its own inverter and MPPT module. In this manner, troubleshooting for a failed or underperforming solar system is easily accomplished. Furthermore, if wired in parallel, oversized inverters from a set of solar panels on support structure 200 can absorb current from an adjacent module where an inverter has failed. A serial arrangement of PV solar modules is also usable with the present disclosure, noting that using framing as conduit will avoid violating high voltage wiring regulations (in the USA).

Operation 418 inquires whether a support structure and attached solar panels needs to be serviced or upgraded. As mentioned, with a parallel and per-module electronics system, a failed or underperforming module is easier to detect. If no removal is needed, then the solar system remains operational.

Operations 420 through 426 provide for removal procedure 419. If a failed module is identified, or is desired for upgrade, then in operation 420, the electrical wiring is decoupled, and in operation 422, the support structure 200 is detached from the building 100-A. This step includes removal of the ridge shingles 119, and sensitive equipment, e.g. optional transceiver assembly 270. Clamping equipment in the roof space can be left in-situ for attaching a replacement module.

In operation 424, support structure 200 is raised off roof 141, e.g. by a boom lift, and placed on transportation away from the work site. Presumably, a replacement module is available for installation afterwards, via operations 402 to 416. Regardless, ridge shingles that were removed in operation 422 are now reinstalled to provide sealing integrity of the roof

By using method 400, the installation and removal of solar systems is accomplished quickly and efficiently. This has the benefit of proliferating usage of PV solar, with the associated environmental benefits. In the case of rental properties, the present system allows tenants to purchase/rent solar PV independently from the property owner since they can restore the property to its original condition upon departure.

### Alternative Embodiments

While the present disclosure focuses on PV solar modules, the present invention is well suited to any type of equipment mounting, including thermal solar, air-conditioning, heat pump, etc. Methods and operations described herein can be in different sequences than the exemplary ones described herein, e.g., in a different order. Thus, one or more additional new operations may be inserted within the existing operations or one or more operations may be abbreviated or eliminated, according to a given application, so long as substantially the same function, way and result is obtained

Although the present embodiments have been described with reference to specific example embodiments, it will be evident that various modifications and changes may be made to these embodiments without departing from the broader spirit and scope of the various embodiments.

The foregoing descriptions of specific embodiments of the present disclosure have been presented for purposes of illustration and description. They are not intended to be exhaustive or to limit the invention to the precise forms disclosed. Many modifications and variations are possible in light of the above teaching without departing from the broader spirit and scope of the various embodiments. The embodiments were chosen and described in order to explain the principles of the invention and its practical application best, to enable others skilled in the art to best utilize the invention and various embodiments with various modifications as are suited to the particular use contemplated. It is intended that the scope of the invention be defined by the Claims appended hereto and their equivalents.

References to methods, operations, processes, systems, and apparatuses disclosed herein, e.g., the transceiver and power electronics power conditioning, that are implementable in any means for achieving various aspects, and may be executed in a form of a machine-readable medium, e.g., computer readable medium, embodying a set of instructions that, when executed by a machine such as a processor in a computer, server, etc. cause the machine to perform any of the operations or functions disclosed herein. Functions or operations may include receiving, transmitting, transceiving, communicating, altering, adjusting, and the like. The term “machine-readable” medium includes any medium that is capable of storing, encoding, and/or carrying a set of instructions for execution by the computer or machine and that causes the computer or machine to perform any one or more of the methodologies of the various embodiments. The “machine-readable medium” shall accordingly include any type of non-transitory tangible medium whether optical, electrical, magnetic, etc. The present disclosure is capable of implementing methods and processes described herein using transitory signals as well, e.g., electrical, optical, and other signals in any format and protocol that convey the instructions, algorithms, etc. to implement the present processes and methods.

Exemplary computing systems for executing instructions described herein include components such as one or more processors for processing data and instructions, coupled to memory for storing information, data, and instructions, where the memory can be computer usable volatile/non-volatile memory. Computing system also includes optional inputs, such as alphanumeric input device including alphanumeric and function keys, or cursor control device for communicating user input information and command selections to processor, an optional display device coupled to bus for displaying information, an optional input/output (I/O) device for coupling system with external entities, such as a modem for enabling wired or wireless communications between system and an external network such as, but not limited to, the Internet. Coupling of components can be accomplished by any method that communicates information, e.g., wired or wireless connections, electrical or optical, address/data bus or lines, etc.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

1. A main support (MS) for mounting equipment on an exterior surface of a roof of a building structure, wherein the roof has an apex, the MS comprising:
a load-bearing member (LBM) comprising:
a first end that includes one or more attach points for retaining the equipment;
a second end; and
an interface member disposed between the first end and the second end, wherein the interface member mates with the roof of the building structure; and wherein:
the second end of the LBM extends beyond the interface member in order to pass through a gap or a hole in the apex of the roof

2. The MS of claim 1, wherein:
the interface member has a shape that mates with a shape of the apex and that is larger than the gap through which the second end passes, in order to provide at least one of a pivot point, a physical support, and a weather shield.

3. The MS of claim 1 further comprising:
a counterbalance member coupled to the LBM, the counterbalance member for bearing a torque-load generated by the equipment.

4. The MS of claim 1 further comprising:
an adapter mount for receiving at least one transceiver, including at least one antenna, wherein:
the adapter mount is disposed towards the first end of the LBM such that the transceiver will be disposed above the apex of the roof in order to provide a line of sight path for transceiving.

5. The MS of claim 4 further comprising:
a cellular transceiver, coupled to the adapter mount, for providing a microcell station for local cellular communications; and
a high-frequency transceiver coupled to the adapter mount, for providing a short reach relay communication to another high-frequency transceiver in a mesh network in order to transmit data between the microcell station and an edge router that is coupled to a switching office or a server.

6. The MS of claim 1 further comprising:
a channel through which one or more power wires and/or one or more ground wires from the equipment can be routed from the roof to a support structure beneath the roof without requiring an additional hole through the roof

7. The MS of claim 1, further comprising:
an electronic-components housing, wherein:
the electronic-components housing includes electronics to operate at least one of the equipment on the roof, and a transceiver; and
the electronic-components housing has a weather rating of indoor or outdoor.

8. (canceled)

9. The MS of claim 7 wherein:
the electronic-components housing is affixed to the LBM as a single assembly for installation through a single gap in the apex of the roof into a protected space of the building structure that is protected by the roof.

10. The MS of claim 4 further comprising:
coupling means disposed on the LBM to receive an electronic-components housing, wherein:
the electronic-components housing includes electronics to operate the antennae; and
the electronic-components housing is installable as an assembly simultaneously with the LBM through a gap in the apex of the roof.

11. The MS of claim 3 wherein:
at least one cross-brace is disposed against an interior structure of the building structure.

12. The MS of claim 3 wherein:
the counterbalance member is disposed on the roof surface without penetrating the roof; and
the counterbalance member includes a standoff disposed against the roof, wherein the standoff transmits compressive loads to the roof surface.

13. The MS of claim 1, wherein:
the LBM has a tubular cross section with an interior cavity through which wiring may be routed.

14. The MS of claim 1 further comprising:
coupling means, for retaining a battery to the MS, wherein:
the adapter mount is disposed towards the second end of the LBM such that the battery will be disposed in an interior space of the building structure.

15. The MS of claim 14 wherein:
the battery is affixed to the LBM as a single assembly for installation through a single gap in the apex of the roof into a protected space of the building structure that is protected by the roof.

16. A support structure (SS) for mounting equipment on a roof of a building structure, the support structure comprising:
at least one support rail, for supporting the equipment; one or more standoffs, coupled to the at least one support rail, for maintaining the equipment away from the roof; and wherein:
the support structure penetrates the roof of the building structure only at an apex of the roof.

17. The support structure of claim 16, wherein:
the equipment is one or more solar panels; and
the support structure requires no fasteners to penetrate the face of the roof in order to retain the support structure to the roof of the building structure, wherein the face of the roof is an area between an outside wall of the building and an apex of the roof.

18. The support structure of claim 16 wherein:
the support structure is preassembled at a location other than the roof for installation on the roof as a single unit.

19. The support structure of claim 16, wherein:
the one or more standoffs have no retention feature to couple them to the roof of the building structure; and
the one or more standoffs transmit only a compressive load toward the surface of the roof without penetrating the roof.

20. The support structure of claim 16, further comprising:
one or more solar panels coupled to the at least one support rail; and wherein:
the support structure is preassembled with solar panels off the roof for installation on the roof as a modular unit.

21. The support structure of claim 16, further comprising:
a main support (MS) comprising:
a load-bearing member (LBM) having a first end, a second end, and an interface member disposed between the first end and the second end, wherein the interface member has a face that mates with an apex of the roof; and wherein:
the interface member is larger than a hole or a gap in the apex of the roof through which the second end of the LBM passes;
the interface member provides at least one of a pivot point for any torque loads from the equipment, a physical support of a weight load of the equipment, and a weather shield for the gap in the apex; and
only the second end of the load-bearing member extends beyond an imaginary plane formed by the interface member in order to penetrate the apex of the roof on which the support structure will be installed.

22. The SS of claim 21, wherein:
the MS absorbs a torque load generated by the equipment on the SS.

23. The SS of claim 16 wherein no tie-down is required to retain a lower end of the support structure.

24. The SS of claim 16 further comprising:
a tie-down member coupled to the at least one support rail and having a length extending from an end of the support rail to an overhang of the roof, such that the face of the roof is not penetrated.

25. The SS of claim 21 wherein only a single tie-down member is required to retain a lower end of the support structure.

26. The support structure of claim 16, wherein:
a plurality of support rails is selectively coupled to each other electrically, according to their polarity, and is selectively coupled to at least one of the load-bearing members electrically, according to polarity, in order to conduct current generated by a solar panel coupled to the support structure.

27. The support structure of claim 26 wherein:
a first support rail electrically coupled to a first polarity of a renewable energy source and to a first LBM to which it is also physically coupled; and
a second support rail electrically coupled to a second polarity of the renewable energy source, and to a second LBM to which it is also physically coupled; and wherein
the first support rail is electrically insulated from the second support rail; and
the first support rail and the second support rail are capable of being electrically coupled to an electrical load as one of a battery, a load in the building structure, and a grid.

28. The SS of claim 21 further comprising:
a housing, for storing at least one of a power electronics and a battery, coupled to the second end of the LBM and disposed below the imaginary plane such that the housing will be located below the roof when installed in the building structure.

29. The SS of claim 21 further comprising:
an adapter mount for receiving at least one transceiver, wherein:
the adapter mount is disposed towards the first end of the LBM such that an antennae mounted to the adapter mount will be disposed above the apex of the roof in order to provide a line of sight for transceiving.

30. The SS of claim 29 further comprising:
a cellular transceiver, coupled to the adapter mount, for providing a microcell station for local cellular communications; and
a high-frequency transceiver, coupled to the adapter mount, for providing a short reach relay communication to another high-frequency transceiver in a mesh network in order to transmit data between the microcell station and an edge router that is coupled to a switching office.

31. The SS of claim 21 further comprising:
a plurality of load-bearing members; and
a plurality of support rails coupled to the plurality of load bearing members; and wherein:
a housing, for at least one of a power electronics and a battery, is disposed between two of the plurality of load bearing members at a location between the second end and the interface member of each of the load bearing members; and
one or more solar panels are disposed on the plurality of load-bearing members.

32. The SS of claim 21 wherein the main support further comprises:
a counterbalance member coupled to the LBM, the counterbalance member for absorbing torque-loads generated by the equipment.

33. The support structure of claim 16 further comprising:
a battery coupled to the load MS; and wherein:
the battery provides backup power for a an electrical system of the building structure.

34. A method of installing a support structure for mounting one or more solar panels on a roof of a building structure, the method comprising:
preassembling the support structure off the roof to create a preassembled structural system, wherein:
the support structure includes at least one main support and at least one standoff; and
the main support has a first end and a second end and an interface member disposed therebetween;
creating an opening in a ridge of the roof to accept the at least one main support of the preassembled structural system; and
lowering the preassembled support structure onto the roof, wherein the support structure penetrates the roof at the ridgeline and is supported on the roof by the at least one standoff.

35. The method of claim 34 wherein:
only the second end of the at least one main support of the support structure penetrates the roof; and
at least one standoff coupled to the support structure transmits a compressive load of the support structure and the solar panels to the roof but does not transmit a tensile load to the roof.

36. The method of claim 34 further comprising:
expanding the opening in the ridge of the roof to receive a housing, containing at least one of a power electronics and a battery, coupled to the second end of the at least one main support and disposed below an imaginary plane of the interface member such that the housing will be located below the roof.

37. The method of claim 34 further comprising:
attaching the support structure to a support structure that supports the roof; and
tying down an end of the support structure disposed furthest from the apex of the roof to the building structure.

38. The method of claim 34 wherein the support structure is a single modular unit for installing on, or removing from, the roof.

39. The method of claim 37 wherein:
the support structure includes an integrated housing, for retaining at least one of a power electronics device and a battery, coupled to the second end of the main support and disposed below the imaginary plane of the interface member such that the housing will be located below an exterior surface of the roof.

40. The method of claim 36 further comprising:
coupling a power wire and a ground wire from the power electronics to a wiring system in the building structure or to a grid.

41. The method of claim 34 further comprising:
removing ridge shingles or tiles from the roof;
installing the structural system;
creating a cutout in the ridge shingles or tiles for the main support disposed at the ridgeline;
installing the ridge shingles or tiles around the main support; and
caulking around an interface between the main support and the cutout in the ridge shingles or tiles.

42. The method of claim 40 further comprising:
decoupling the power wire and the ground wire from the power electronics for replacing a defective support structure or a defective solar panel disposed thereon;
detaching the support structure from the support structure that supports the roof;
removing the support structure from the building structure as a single modular unit; and
installing a replacement support structure with solar panels.

43. The method of claim 34 further comprising:
installing solar panels on the support structure prior to the lowering operation.

44. A building structure having a roof on which equipment can be mounted, the building structure comprising:
a support structure comprising:
at least one main support for supporting equipment on the roof of the building structure, the main support comprising:
a load-bearing member having a first end and a second end; and wherein:
the load-bearing member pierces the roof at an apex of the roof and attaches to the building structure in an interior space of the building structure.

45. The building structure of claim 44 wherein:
the support structure only pierces a plane of the roof at approximately at the apex of the roof, in order to maintain roof integrity.

46. The building structure of claim 44 wherein the structural system further comprises:
at least one standoff coupled to the at least one main support, wherein the at least one standoff does not pierce the roof

47. The building structure of claim 44 wherein the support structure further comprises:
a tie down structure coupled to the at least one main support and to the building structure; and wherein:
the tie down structure pierces the roof or ties to an overhang of the roof without piercing the roof.

48. The building structure of claim 44 further comprising:
a power electronics device for operating solar panels, wherein the power electronics are disposed beneath the roof of the building structure.

49. The building structure of claim 44 further comprising:
at least one transceiver coupled to the support structure.
